(19) United States
(12) Patent Application Publication
(10) Pub. No.: US 2026/0362532 A1
(43) Pub. Date: Nov. 12, 2026

(54) MODULAR RRC RE-ESTABLISHMENT

(71) Applicant: InterDigital Patent Holdings, Inc., Wilmington, DE (US)

(72) Inventors: Brian Martin, Farnham (GB); Martino Freda, Laval (CA); Keiichi Kubota, Setagaya-Ku (JP); Samuli Turtinen, Ii (FI); Faris Alfarhan, Montreal (CA); Paul Marinier, Brossard (CA); Tuong Hoang, Montreal (CA); Francois Periard, Montreal (CA); Pascal Adjakple, Great Neck, NY (US); Diana Pani, Montreal (CA); Ghyslain Pelletier, Montreal (CA); Benoit Pelletier, Roxboro (CA)

(73) Assignee: InterDigital Patent Holdings, Inc., Wilmington, DE (US)

(21) Appl. No.: 19/202,661

(22) Filed: May 8, 2025

(51) Int. Cl. H04W 76/19; H04W 36/14

(52) U.S. Cl. CPC H04W 76/19; H04W 36/14

(57) ABSTRACT

Devices and methods for re-establishment in wireless networks are disclosed herein. A wireless transmit/receive unit (WTRU) receives configuration parts for a current cell where each configuration part is associated with an identifier. When the WTRU detects a failure, a target cell is selected. The WTRU compares identifiers corresponding to the target cell to those identifiers corresponding to stored configuration parts and applies the stored configuration parts with matched identifiers. The WTRU indicates to the target cell matched/unmatched identifiers, receives the missing/unmatched configuration parts, and applies those configuration parts in addition to the configuration parts with matched identifiers.

### BACKGROUND

Mobility in New Radio (NR) is based on radio resource control (RRC) reconfiguration. In RRC reconfiguration, a wireless transmit/receive unit (WTRU) receives an RRC message with a full configuration of all possible RRC parameters, or a delta configuration which changes only certain RRC parameters to be changed, leaving the parameters not included to be unchanged compared to the currently stored/applied configuration.

### SUMMARY

An example wireless transmit/receive unit (WTRU) is disclosed that includes a processor. The processor is configured to determine that a first set of configuration parts are activated for the WTRU for a serving cell, wherein a first respective identifier is associated with each configuration part of the first set of configuration parts, and wherein each configuration part of the first set of configuration parts corresponds to a protocol module that is applicable in one or more operation modes. The processor is further configured to detect a connection failure with the serving cell and select a target cell. The processor is further configured to receive an indication of second respective identifiers associated with each configuration part of a second set of configuration parts, wherein the second set of configuration parts are associated with the target cell. The processor is further configured to determine, based on the first respective identifiers and the second respective identifiers, a matched portion of the second set of configuration parts that are included in the first set of configuration parts that are activated for the WTRU for the serving cell, and an unmatched portion of the second set of configuration parts that are not included in the first set of configuration parts that are activated for the WTRU for the serving cell. The processor is further configured to send, to the target cell, an indication of respective identifiers of the matched portion of the second set of configuration parts. The processor is further configured to receive, from the target cell, a configuration for a subset of the unmatched portion of the second set of configuration parts that are associated with the target cell.

In examples, each configuration part of the first set of configuration parts comprises at least a partial configuration for one or more target cells. In examples, each operation mode of the one or more operation modes is associated with one or more capabilities of the WTRU. In examples, the processor is further configured to apply the matched portion of the second set of configuration parts and the unmatched portion of the second set of configuration parts. In examples, the matched portion of the second set of configuration parts and the unmatched portion of the second set of configuration parts, together, form a full configuration for the WTRU with the target cell. In examples, the processor is further configured to receive configuration information, wherein the configuration information comprises more configuration parts than the first set of configuration parts that are activated for the WTRU. In examples, the processor is further configured to determine that at least one configuration part of the first set of configuration parts that are activated are applicable in the target cell based on an identifier associated with the at least one configuration part having the same value as an identifier associated with at least one configuration part of the second set of configuration parts associated with the target cell. In examples, the processor is configured to send, to the target cell, an identifier associated with the serving cell. In examples, the processor is configured to activate the first set of configuration parts based on an indication from the serving cell or based on detection of one or more conditions, wherein the one or more conditions comprise at least one of (i) one or more measurements associated with at least one of a source cell or a neighboring cell, or (ii) one or more timers. In examples, the processor is configured to detect the connection failure with the serving cell based on a radio link failure, a hand-over failure, a reconfiguration failure, a security failure, or a radio link control failure.

An example method performed by a wireless transmit/receive unit (WTRU) is disclosed. The method involves determining that a first set of configuration parts are activated for the WTRU for a serving cell, wherein a first respective identifier is associated with each configuration part of the first set of configuration parts, and wherein each configuration part of the first set of configuration parts corresponds to a protocol module that is applicable in one or more operation modes. The method further involves detecting a connection failure with the serving cell and selecting a target cell. The method further involves receiving an indication of second respective identifiers associated with each configuration part of a second set of configuration parts, wherein the second set of configuration parts are associated with the target cell. The method further involves determining, based on the first respective identifiers and the second respective identifiers, a matched portion of the second set of configuration parts that are included in the first set of configuration parts that are activated for the WTRU for the serving cell, and an unmatched portion of the second set of configuration parts that are not included in the first set of configuration parts that are activated for the WTRU for the serving cell. The method further involves sending, to the target cell, an indication of respective identifiers of the matched portion of the second set of configuration parts. The method further involves receiving, from the target cell, a configuration for a subset of the unmatched portion of the second set of configuration parts that are associated with the target cell.

In examples, each configuration part of the first set of configuration parts comprises at least a partial configuration for one or more target cells. In examples each operation mode of the one or more operation modes is associated with one or more capabilities of the WTRU. In examples, the method further involves applying the matched portion of the second set of configuration parts and the unmatched portion of the second set of configuration parts associated with the target cell. In examples, the matched portion of the second set of configuration parts and the unmatched portion of the second set of configuration parts, together, form a full configuration for the WTRU with the target cell. In examples, the method further involves receiving configuration information, wherein the configuration information comprises more configuration parts than the first set of configuration parts that are activated for the WTRU. In examples, the method further involves determining that at least one configuration part of the first set of configuration parts that are activated are applicable in the target cell based on an identifier associated with the at least one configuration part having the same value as an identifier associated with at least one configuration part of the second set of configuration parts associated with the target cell. In examples, the method further involves sending, to the target cell, an identifier associated with the serving cell. In examples, the first set of configuration parts and the second set of configuration parts are applicable within multiple cells and for particular operation modes. In examples, the method further involves activating the first set of configuration parts based on an indication from the serving cell or based on detection of one or more conditions, wherein the one or more conditions comprise at least one of (i) one or more measurements associated with at least one of a source cell or a neighboring cell, or (ii) one or more timers. In examples, the method further involves detecting the connection failure with the serving cell based on a radio link failure, a hand-over failure, a reconfiguration failure, a security failure, or a radio link control failure.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating radio link monitoring (RLM) and radio link failure (RLF) detection procedures.

FIG. 3 is a diagram illustrating a radio resource control (RRC) re-establishment procedure.

FIG. 4 is a flow diagram illustrating a re-establishment procedure according to an embodiment.

FIG. 5 is a flow diagram illustrating a re-establishment procedure according to an embodiment

### DETAILED DESCRIPTION

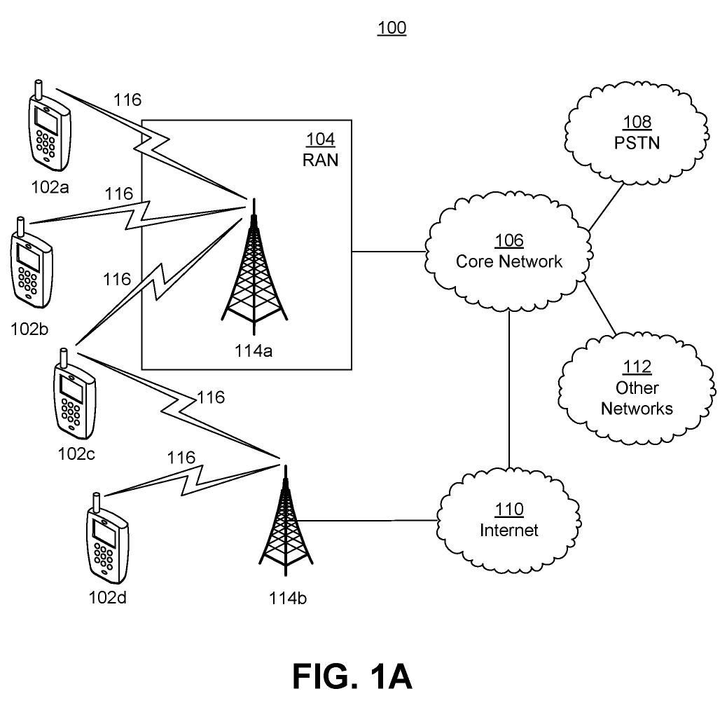

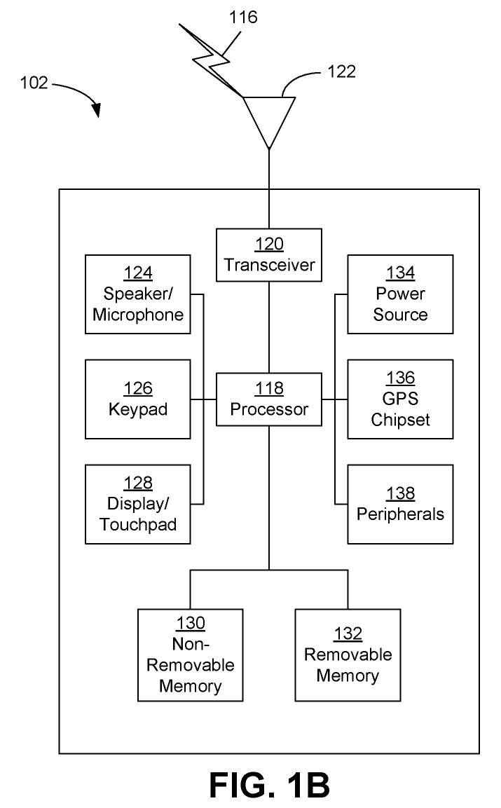

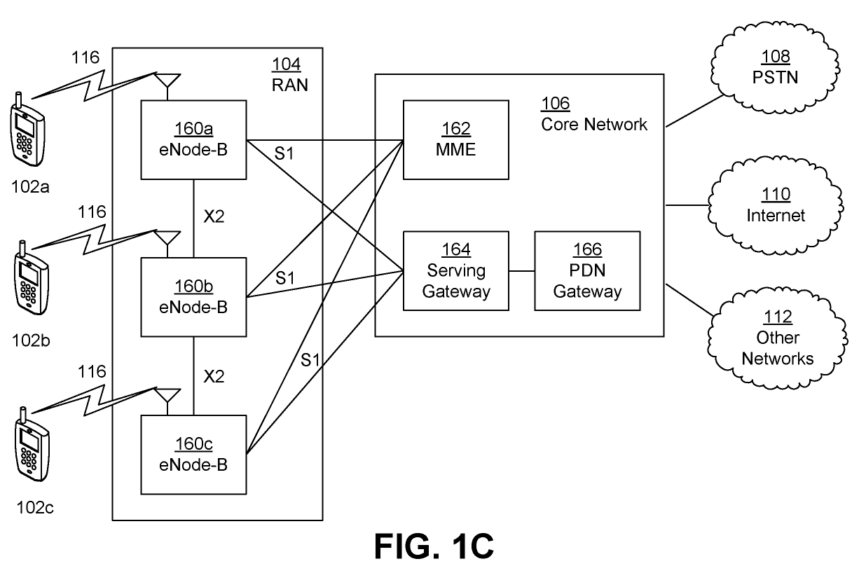

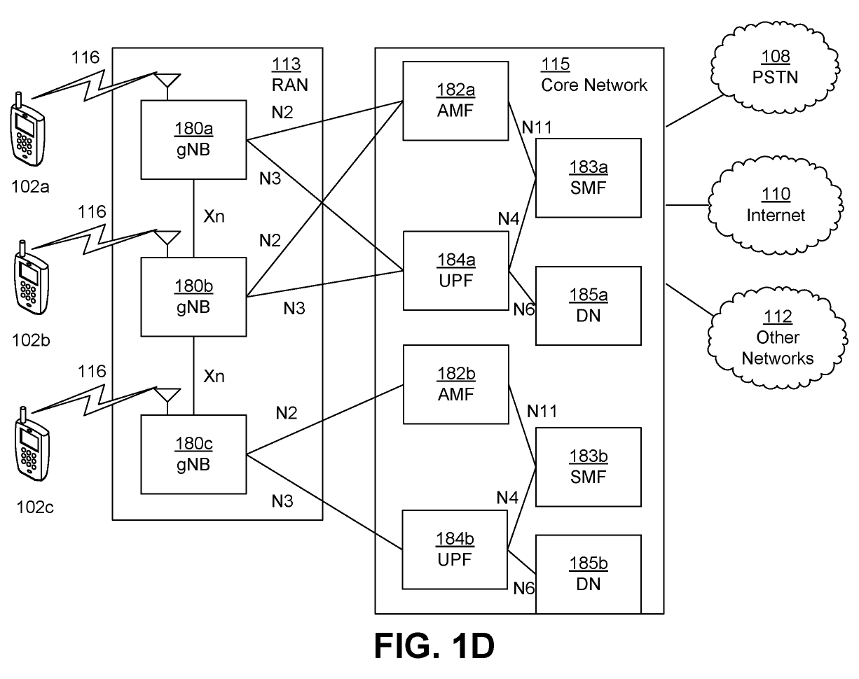

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114aand the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114band the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114bmay not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160cmay each include one or more transceivers for communicating with the WTRUs 102a, 102b, 102c over the air interface 116. In one embodiment, the eNode-Bs 160a, 160b, 160cmay implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Radio access network (RAN) is currently being studied. More particularly, the incorporation of sensing and artificial intelligence/machine learning (AI/ML) into the RAN is being considered.

Further, there is an effort towards a design which tailors to different categories of WTRUs and different verticals. For example, to avoid the errors where narrowband (NB) IoT and similar low complexity device designs required a re-work or limitation of the NR baseline, such devices may already be taken into consideration.

Mobility in NR is based on RRC reconfiguration. In radio resource control (RRC) reconfiguration, a WTRU receives an RRC message with a full configuration of all possible RRC parameters, or a delta configuration which changes only certain RRC parameters to be changed, leaving the parameters not included to be unchanged compared to the currently stored/applied configuration.

In handover, a WTRU receives an RRC configuration of the target cell in the handover command. The RRC configuration can be a full configuration or delta configuration and represents the WTRU’s configuration to use in the target cell.

To reduce the latency associated with L3 mobility, NR also introduces L1/L2 mobility (LTM). In LTM, the WTRU receives a list of candidate cell configurations in advance (e.g., before the handover). The cell switch command is issued with a cell identifier (ID), and the WTRU simply uses the cell configuration it has stored for the respective cell.

While in RRC_CONNECTED state, the WTRU performs radio link monitoring (RLM) on the serving cell. The serving cell may refer to a primary cell in the case of multiple cells configured for carrier aggregation. The WTRU is configured with timers and counters to use when detecting radio link failure (RLF) and performing radio link recovery or re-establishment.

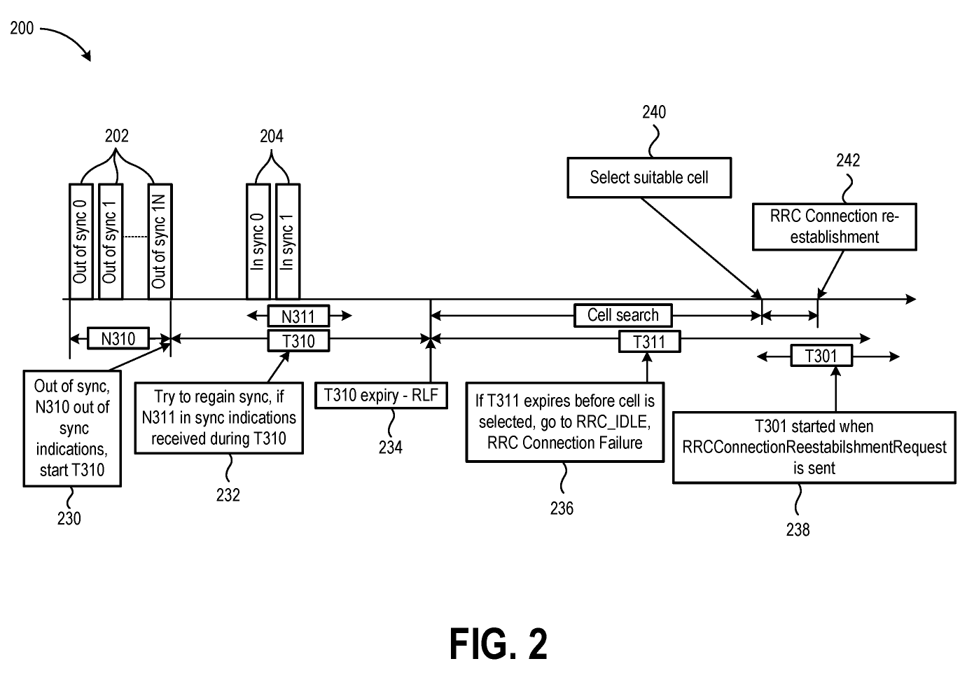

FIG. 2 is a diagram illustrating RLM and RLF detection procedures.

The physical layer (PHY) sends out of sync (OOS) indications 202 and in sync (IS) indications 204 to the RRC based on whether the serving cell’s signal to interface plus noise ratio (SINR) is below or above a configured SINR threshold.

At 230, upon the detection of N310 consecutive OOS indications 202 from PHY, RRC starts a timer with a duration of T310.

At 232, while T310 is running, the WTRU attempts to recover the radio link on the serving cell. If N311 consecutive IS indications 204 are received at RRC from PHY, then the timer is stopped and the WTRU considers the radio link to have been recovered and resumes normal operation and continues RLM on the serving cell.

If T310 expires before the N311 consecutive IS indications 204 are received, then the WTRU considers this as an RLF at 234. Upon detection of RLF, a timer is started with the duration of T311, and the WTRU performs a cell search in order to determine whether there is a suitable cell available on which the WTRU may perform RRC connection re-establishment.

If the timer T311 expires before the WTRU finds a suitable cell, then the WTRU enters RRC_IDLE mode with the cause “RRC Connection failure” at 236.

If the WTRU does find a suitable cell (which could be the original serving cell) then this cell is selected at 240, T311 is stopped, T301 is started, and an RRC Connection re-establishment procedure is started at 242. If the timer T301 expires before the RRC Connection re-establishment is complete, then the WTRU enters idle mode with the cause “RRC Connection failure”.

An RLF may occur, for example, when the WTRU goes out of coverage (e.g., entering a tunnel or moving to a rural area out of cellular coverage). An RLF may occur, for example, as a result of too late handover, whereby RLF is detected on the serving cell before a handover can be completed. The first part of the procedure (e.g., N310, T310, N311) is intended to allow the WTRU a chance to recover the radio link in case of a temporary problem. The second part of the procedure after T310 expiry is intended to allow the WTRU to attempt to re-establish the connection on the same or another cell without having to release the connection completely.

Upon detecting an RLF according to any of the foregoing causes, the WTRU performs an RRC re-establishment to recover the radio link. In addition to RLF, there are also several other triggers for the WTRU to trigger re-establishment, such as (i) upon re-configuration with sync failure with the target cell during handover, (ii) upon HO failure from NR to another RAT, (iii) upon integrity check failure for CP data (e.g., data received via SRB1 or SRB2), and (iv) upon RRC connection reconfiguration failure (e.g., WTRU unable to compile/execute the received RRC reconfiguration file).

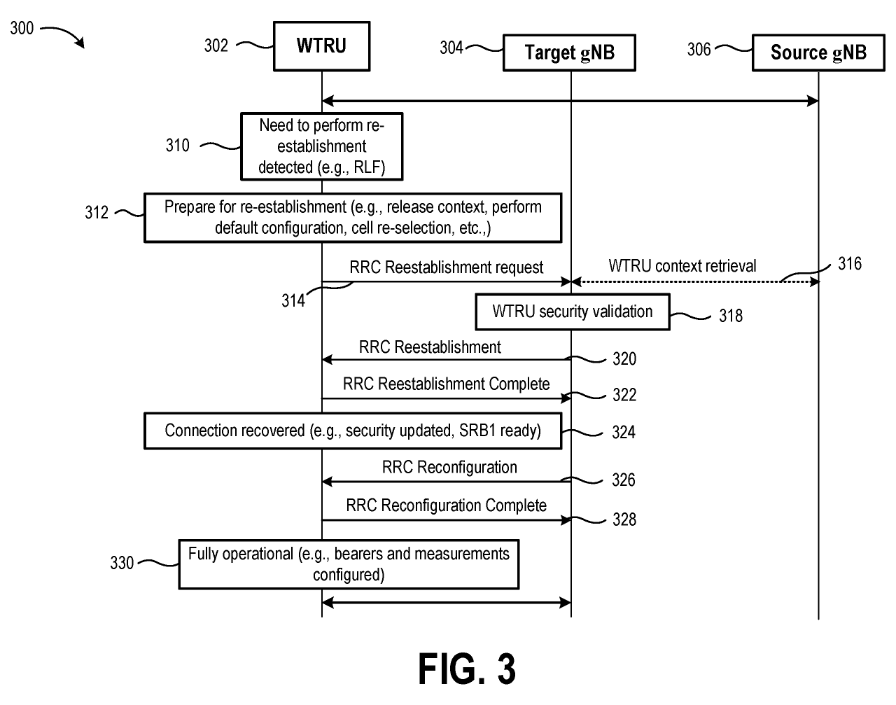

FIG. 3 is a diagram of a RRC re-establishment procedure in NR. During the re-establishment procedure, the WTRU may perform several functions, such as reset the MAC, release the WTRU configuration/context (including security configuration), reform cell re-selection (e.g., select the cell with the best radio quality the WTRU can measure at the time, apply default configurations, and/or send an RRC re-establishment request message to the network. For example, in FIG. 3, WTRU 302 may detect a need to perform re-establishment at 310. WTRU 302 may then prepare for re-establishment at 312 (e.g., release context, perform default configuration, perform cell re-selection, etc.). At 314, WTRU 302 may send an RRC re-establishment request to a target gNB 304. The RRC re-establishment request may include information such as the identity of the WTRU (e.g., C-RNTI) at the source cell where the re-establishment was triggered, the PCI of the source cell, security integrity information that is derived based on the security configuration that was used at the source cell, the cause of the re-establishment (e.g., RLF, integrity verification failure, reconfiguration failure, etc.).

At 315, target gNB 304 and a source gNB 306 may perform context retrieval and at 318 target gNB 304 may perform WTRU security validation. At 320, target gNB 304 may send an RRC re-establishment message. At 322, WTRU 302 may send an RRC-re-establishment complete message when RRC re-establishment is completed. At 324, connection may be recovered at WTRU 302 (e.g., security is updated, SRB1 is ready, etc.). At 326, target gNB 304 may send an RRC reconfiguration message. At 328, WTRU 302 may send an RRC reconfiguration complete message when RRC reconfiguration is completed. At 330, WTRU 302 may be fully operational (e.g., bearers and measurements are configured).

If the WTRU is configured with conditional reconfiguration (CHO) and/or L1/2 triggered mobility (LTM), the WTRU may perform a slightly enhanced re-establishment procedure. The WTRU may not release its context/configuration at the start of the re-establishment procedure, but may determine if the cell re-selection procedure results in a selecting a cell that is a CHO target (e.g., WTRU already has a CHO stored for that target) or an LTM candidate (e.g., WTRU already has an LTM candidate cell configuration for the target). If so, there may be no need to continue with the re-establishment procedure and the WTRU may execute the associated CHO command or LTM candidate configuration.

A modular RRC design may enable more efficient signaling by allowing each component function to operate independently for specific aspects of user plane (UP) operation. This modularity also allows network deployments to provide configurations efficiently, without requiring users to be aware of the underlying network architectural split. It enhances user experience and simplifies network management.

Radio resource management (RRM), which includes mobility, link management, QoS, UP configuration, failure recovery procedures, and performance monitoring, plays a critical role in optimizing the performance of cellular networks. RRM must be scalable to handle variable traffic loads, support diverse use cases and optimize spectrum efficiency. As networks expand and densify, the use of massive multiple input, multiple output (MIMO) and small cells requires more efficient coordination. With the growth of IoT and machine-to-machine (M2M) communications, the RRM is additionally being challenged with more difficult scheduling, interference mitigation, and power control issues as the number of devices expands exponentially.

The RRM interacts with the control plane (CP) to allocate and schedule radio resources according to network policies and real-time conditions, balancing fairness between users while optimizing radio resources for both transmissions and receptions.

An enhanced QoS framework may introduce greater flexibility and adaptability. Rather than relying on agreed-upon, hard QoS guarantees that the network is required to fulfill, regardless of the network conditions, soft QoS guarantees may allow services to specify acceptable ranges for QoS attributes such as data rate, latency and packet error rate, offering a more dynamic and efficient approach to managing network performance based on current conditions.

This new QoS framework may enable operators to meet minimum QoS requirements while aiming to provide QoS at or near the target values of specified attribute ranges, enhancing the overall quality of experience (QoE) for end users. The envisioned operation with soft QoS guarantees can be achieved by adding a new resource type such as adaptive QoS, along with the necessary operational enhancements within the existing 3GPP QoS framework.

Another important aspect in RRM is mobility management, which is essential to ensure seamless connection while moving or stationary. Refining the handover procedures may enhance mobility. The most effective components may be integrated into a unified framework. This may create a robust baseline for mobility, leveraging the strengths of existing technologies to achieve an improved handover experience.

Radio access network (RAN) is currently being studied. More particularly, including the incorporation of sensing and artificial intelligence/machine-learning (AI/ML) into the RAN is being considered. Further, there is an effort towards a design which tailors to different categories of wireless transmit/receive units (WTRUs) and different verticals. For example, to avoid errors where narrowband (NB) internet of things (IoT) and similar low complexity device designs require a re-work or limitation of the NR baseline, such devices may already be taken into consideration. Several other considerations include (i) implementing a scalable and modular design that allows a wide range of features, device types, services, and spectrum bands to be developed and deployed as needed, (ii) supporting diverse IoT device types and use cases with a focus on long-term commitments and multi-generational solutions, and (iii) diverse device types with scalable design based on, for example bandwidth/data rate, form factor, and/or energy consumption.

Network energy saving is also an important consideration. For example, features which improve the network energy consumption, such as being able to switch off SIB1 transmission and being able to switch off some of the broadcast reference signals may be implemented.

Another design consideration is simplicity and streamlining of the functionality, the same functionality, avoiding excessive configurations, etc.”

The current radio link failure (RLF) and radio resource control (RRC) re-establishment procedures used in new radio (NR) are relatively verbose. First, the WTRU attempts to recover the link on the source cell for a certain time (T310). Then the WTRU performs a cell search. Next, the WTRU transmits an RRC message and receives another RRC message containing the configuration for the new cell. This leads to a long interruption to the user service while the WTRU attempts to reconnect to the network.

Solutions adopted in NR include early RLF detection. Early RLF detection involves reducing the timer used by the WTRU for attempting to reconnect to the previous cell before attempting re-establishment. The WTRU may apply a conditional handover (CHO) or L1/L2 mobility (LTM) configuration if the WTRU has a stored CHO or LTM configuration for the selected cell.

One observation is that within a particular operator network, often much of the configuration is the same across multiple cells. When performing a L3 based reconfiguration (e.g., handover) this is somewhat addressed by use of a “delta” configuration, whereby the RRC reconfiguration (e.g., the handover command) provides the parameters which are different in the target cell compared to what is already configured in the source cell. For LTM, this has been extended such that a “reference configuration” can be provided, while for each candidate configuration a “delta” is provided compared to the reference configuration.

While mobility latency has been somewhat addressed by the introduction of LTM, enabling the WTRU to store configurations for candidate cells, perform uplink and downlink synchronization to target cells ahead of cell switch, trigger reconfiguration using medium access control (MAC) control element (CE) signaling, and perform random access channel (RACH)-less handover, the re-establishment procedure is still relatively slow because WTRU must perform cell selection, RACH, synchronization, and apply a full configuration (e.g., by executing and applying a stored LTM or CHO configuration, or by receiving a full configuration from the target cell by RRC signaling) upon finding a suitable cell on which to re-establish the RRC Connection.

In embodiments, a WTRU may receive configuration parts (e.g., corresponding to protocol modules) for first (e.g., current) cell, and potentially also candidate cells and each configuration part is associated with an identifier. When the WTRU detects a failure (e.g., RLF), a second (e.g., new) cell is selected. WTRU compares identifiers corresponding to the second cell to those identifiers corresponding to stored configuration parts and applies the stored configuration parts with matched identifiers.

The WTRU may indicate to the second cell (e.g., in RRC Connection re-establishment request) matched/unmatched identifiers, then receives (e.g., via RRC connection re-establishment) missing/unmatched configuration parts, and may apply those.

First, a WTRU may receive, from a first cell, one or more configuration parts, and one or more configuration part identifiers for determining applicability. As used herein, “configuration parts” correspond to protocol modules applicable in certain operation modes. Configuration parts may be applicable within multiple cells and for particular operation modes.

The WTRU may activate one or more configuration parts. The WTRU may activate one or more configuration parts based on explicit indication from network and/or based on one or more conditions. The one or more conditions may be based on one or more measurements associated with one or more cells (e.g., a serving cell measurement is above a threshold, a neighbor cell measurement is better than the serving cell, etc.) and/or timer-based (e.g., if there is a DRX timer whereby no data has been scheduled for a certain time, the power saving configuration may be activated).

The WTRU may detect an RRC Connection failure on the current cell (e.g., RLF, handover failure (HOF), reconfiguration failure, security failure, radio link control (RLC) failure, etc.). The WTRU may perform measurements and may select a second cell (e.g., perform cell selection).

The WTU may receive the relevant configuration part identifiers corresponding to the second cell. For example, the WTRU may receive the relevant configuration part identifiers corresponding to the second cell. For example, the WTRU may acquire the system information (e.g., the minimum system information).

The WTRU may determine the configuration parts applicable in the second cell based on the one or more stored configuration parts which have the same value as the configuration part identifiers received on the second cell. Each configuration part which has an identifier that is also present in the second cell is valid in the second cell.

The WTRU may apply the stored configuration parts having identifiers corresponding to the second cell which match the identifiers of the stored configuration parts. This may include keeping the matched active configuration parts. The WTRU may indicate (e.g., in RRC Re-establishment request) the source cell identifier, and the stored identifiers (e.g. for both the matched and unmatched configuration parts).

The WTRU may receive a configuration for the unmatched configuration parts and may apply those on top of the already applied configuration parts.

RRC Re-establishment signaling and latency may be minimized by allowing the WTRU to apply the relevant configuration parts already stored that are applicable to the new cell, even if it’s not a configured mobility candidate, and as long as it belongs to a certain group of cells (e.g., same distributed unit (DU), same centralized unit (CU), same RAN-based Notification Area (RNA), etc.).

Synchronization signal block (SSB) or Synchronization signal (SS)/physical broadcast channel (PBCH) block, which may include at least one of the following: primary synchronization signal (PSS), secondary synchronization signal (SSS), PBCH (e.g., data, MIB), and/or PBCH (e.g., DMRS). The SSBs may be transmitted by the network node (e.g., base station, TRP, relay node, reconfigurable intelligent surface (RIS) unit) in different directions as beams. The number of SSB beams in an SSB burst set, which may be transmitted periodically within an interval (e.g., 5ms) may depend on the carrier frequency. For example, an SSB burst may contain 4 SSBs for FR1 (< 3GHz), 8 SSBs for FR1 (3 to 6GHz) and 64 SSBs for FR2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the network node or WTRU (e.g., via transmission of an uplink (UL) wake-up signal (WUS)). Some SSBs may include slim/lean SSBs, which may comprise of PSS only, PSS and SSS-only, PBCH or a subset of MIB-only, for example. In future systems, an SSB may use a different design. For example, the SSN may contain new reference signals and transmit in a manner which allows basic (e.g., low capability) devices to receive on a very narrow bandwidth.

As used herein, system Information block may refer to any information which is broadcast by the network, either always or upon request, to enable devices to perform the first steps for initial access. System information may consist of information related to uplink resources (e.g., random access channel (RACH)), but may also contain additional information. For example, system information may contain neighbor cell information enabling the WTRU to perform mobility between cells in an idle state, check whether access to cells are allowed, receive information related to emergency notification systems such as earthquake and tsunami warning system (ETWS) or commercial mobile alert system (CMAS), and other information which may be used by WTRUs in an idle state or when connecting to the cell. In NR, the system information consists of a master information block (MIB), minimum system information (SIB1), and other system information (e.g., SIB2 through SIB25). Future systems may or may not use the same structure. However, there may be at least some minimum information used for the very first uplink communication broadcast in a first block similar to MIB and/or some further information crucial for connecting with the cell in a second block similar to SIB1.

Channel state information reference signal may include one or more of the following: CSI-RS resource set (ID), CSI-RS resource (ID/index), resource mapping, power control offset values (e.g., with respect to physical downlink shared channel (PDSCH), SSB, etc.), scrambling ID, periodicity, offset and QCL info. CSI-RS may be transmitted in downlink by the network node as CSI-RS beams, via different resource types including periodic, semi-persistent and aperiodic. In future systems, CSI-RS may be transmitted upon request (e.g., on demand) to support measurements and beam management for connected devices and may be transmitted using a new signal design.

Any conditions relating to the state of the radio/channel may be determined by the WTRU from one or more of: a WTRU measurement (e.g., L1/SINR/ reference signal received power (RSRP), channel quality indicator (CQI)/modulation and coding scheme (MCS), channel occupancy, received signal strength indicator (RSSI), power headroom, exposure headroom), L3/mobility-based measurements (e.g. RSRP, reference signal received quality (RSRQ), s-measure), an RLM state, and/or channel availability in unlicensed spectrum (e.g., whether the channel is occupied based on determination of an LBT procedure or whether the channel is deemed to have experienced a consistent LBT failure). The network may determine uplink channel conditions using a reference signal transmitted by the device.

As used herein, a configuration part may comprise at least a partial configuration for one or more source cells and/or target cells. Additionally, or alternatively, a configuration part may correspond to a protocol module that is applicable in certain operation modes.

Throughout this disclosure, terms, channels, and protocol design for NR may be used. However, it should be understood that the methods taught apply equally to any cellular network, which may use different definitions for channels, signals, and so on. In the context of a future generation wireless network, some functions may or may not be necessary, depending on the system architecture, protocol design, and physical channel design. However, it is assumed that a system operates using the general principle that configurations are provided by an upper (e.g., RRC) layer, which apply to multiple target cells, beam, or TRPs and the lower layer (e.g., MAC, L1) controls switching between the configurations. In some designs, all or part of the configuration might come from lower layers (e.g., MAC). This may be in case different network nodes are responsible for providing their own configuration, such as a DU providing a L2 configuration and a CU providing a L3 configuration, which may use their own signaling procedures and design. In some system designs, the radio nodes of the network may be split into CU, DU, and radio unit (RU). A CU may control one or more DUs, and a DU may control one or more RUs. In some designs, the DU configuration may be provided to the CU and transmitted to the WTRU from the CU using RRC signaling, similar to NR. In another alternative the DU may provide its configuration directly to the WTRU using L2 signaling.

The solutions herein are described in terms of accessing a new radio access technology

A modular protocol design may include one or more of the following: (i) an “anchor” baseline protocol supporting the lowest capability device, (ii) additional processing and protocol components for higher capability or operation modes, (iii) RRC Configuration threads encoded/decoded in parallel, (iv) Simplified WTRU configuration structure, (v) stored configurations across state transitions, and/or (vi) improved latency.

A modular protocol design may include an “anchor” baseline protocol supporting the lowest capability device. For example, the smallest supported bandwidth and/or minimum data rate and processing capability.

A modular protocol design may include additional processing and protocol components for higher capability or operation modes. For example, wider bandwidth, additional bandwidth parts, additional carriers or resources, additional processing capabilities such as a larger number of HARQ processes or additional functionality.

A modular protocol design may include RRC Configuration threads encoded/decoded in parallel. For example, RRC configuration of the MAC layer (or any protocol layer) may be separate to RRC configuration for RRM (or any other functionality). In another example, the DU may configure functionality terminated in the DU (e.g., MAC) and CU may separately configure functionality terminated at the CU (e.g., RRC based RRM, or packet data convergence protocol (PDCP) layer functionality, etc.).

A modular protocol design may include simplified WTRU configuration structure. For example, ASN.1 encoding to be modelled based on lists rather than entirely nested structures.

A modular protocol design may include stored configurations across state transitions. For example, the WTRU may be moved between a power saving state (e.g., RRC_INACTIVE) and an active state (e.g., RRC_CONNECTED) using previously stored configurations, not needing a full RRC reconfiguration to change the state.

A modular protocol design may include improved latency. For example, state changes or reconfiguration achieved by pre-stored configurations applied upon L2 (e.g., MAC CE) signaling.

Options for defining “protocol modules” for modular protocol may include one or more of the following: (i) capability based, (ii) building block/bolt-on based on functionality/operation modes or to transfer small amounts of delay tolerant data, and/or (iii) network architecture based.

An option for defining “protocol modules” for modular protocol may be capability based. For example, a protocol module may be a module based on low capability (e.g., anchor protocol), a module based on eMBB capability, etc. A protocol module may be a combination of what a WTRU supports and a network supports. For example, if a WTRU and a network support multiple module options, then the selected module may be the highest capability module supported by both. A protocol module may have multiple modules active at the same time. For example, a protocol module may have (i) a minimum capability for small amount of data, signaling, initial access, etc., (ii) intermediate capability for relatively low throughput data, and/or (iii) higher capability based on QoS requirements (e.g. lower latency, higher throughput, wider BW, higher reliability, better latency).

An option for defining “protocol modules” for modular protocol may be Building block/bolt-on based on functionality/operation modes or to transfer small amounts of delay tolerant data. For example, a first module may correspond to a “low capability”, which could be used by any device to perform registration signaling. A second module may add more throughput capability, for example additional carriers, resources, or L2 processing (e.g., HARQ processes, RLC functionality, memory/buffer), and may be enabled in parallel to the first module. A module may be added to enable certain functionality, corresponding to one or more of: (i) mobility (e.g., depending on the type of mobility configuration being enabled), (ii) link management, (iii) QoS, (iii) user plane configuration, (iv) control plane configuration, (v) failure recovery mechanisms, (vi) power saving mechanisms (e.g., DRX or network energy saving), and/or (v) different modules may correspond to different states of the WTRU (e.g., one module for power saving and another for latency). Low capability as first module may be okay for signaling and/or initial access. A second module may add low throughput data. For example, a second module may add more memory and/or buffer, additional L2 parts (e.g., more HARQ processes, more RLC capabilities, etc.), and/or user plane, data plane, and/or control plane modules. The third module may add low latency and/or high reliability. A protocol module may encapsulate all of the functionality for a particular feature or set of features, providing the parameters and configuration across multiple protocol layers. For example, enabling a high throughput service may require configurations at L1, MAC, RRC, etc.

An option for defining “protocol modules” for modular protocol may be network architecture based. For example, if a DU is able to configure itself, one module could be DU related configuration (e.g., MAC). Another module could be CU related (e.g., RRC, RU related). A module may correspond to (e.g. be applicable in) multiple cells and/or areas in the network.

Configuration parts may be used to (e.g., independently) to control or configure different modules, or parts of modules, in the WTRU. For example, one configuration part may describe, for example, a MAC configuration or a mobility configuration. One configuration part may describe a power saving configuration or a low latency configuration.

One configuration part may describe the “anchor” or baseline protocol (e.g., lowest capability), while other configuration parts may describe the configuration for additional processing and protocol components for higher capability or operation modes.

A configuration part may describe a combination of modules, smaller parts of individual modules, and/or may directly correspond to a particular module.

Some configuration parts may be common across multiple cells. For example, RRC configuration parts could be relevant to a particular group of cells such as cells bellowing to the same CU (e.g., “upper” RRC L3 configuration), same DU (e.g., L1/2 configuration), and/or same RU (e.g., L1 configuration), the same location area or RAN notification area, or any combination of cells using the same or similar configuration for at least part of the complete configuration.

Configuration parts may be partly or wholly specific to a particular operation mode (e.g., eMBB mode, power saving mode, low latency mode, IoT/minimum capability mode).

An operation mode may refer to a mode in which a particular one or more protocol modules are active. For example, in NR there are different RRC states, which may be described as operation modes. In the RRC_CONNECTED operation mode, the WTRU has a dedicated Radio Network Temporary Identifier (RNTI), is scheduled using PDCCH for reception on PDSCH and transmission on PUSCH, mobility is controlled by the network, and measurements are performed using specific RSs. In the RRC_INACTIVE mode, the WTRU stores the connected mode context, uses common channels to start data transmission or reception (e.g., is reachable by paging or can initiate an RRC resume using RACH), and mobility is WTRU based using idle mode RSs.

In future systems, there may be at least one connected state (e.g., RRC_CONNECTED). In contrast to NR, there may be multiple operation modes in the RRC_CONNECTED state. The operation modes may correspond directly to modules or configuration parts, or may consist of multiple (e.g., a combination of) modules or configuration parts. For example, the mobility mode of the WTRU in RRC_CONNECTED may be changed by enabling either a network-controlled mobility configuration, or a WTRU controlled mobility configuration. In another example, the operation mode may relate to the active services, configurations, capabilities, protocol components, and/or any of the options as described for modular protocol.

The operation mode may modify the type of measurements being performed. For example, in one mode the WTRU may be configured to measure one type of reference signal on a neighbor cell (e.g., to perform cell-based evaluation for a conditional handover). In another mode the WTRU may be configured to measure another type of reference signal on a neighbor cell (e.g., to perform beam management or beam-based handover, such as LTM). The change of measurement type may be implicit depending on the current mode. For example, if the WTRU is moved to a power saving operation mode, the WTRU may implicitly start performing measurements on more infrequent reference signals, or reference signals transmitted using a wider beam, in order to be able to switch off the receiver (e.g., DRX) for extended periods. While in a data transfer mode the WTRU may start performing measurements on a more frequent RS or narrower beam RSs.

The operation mode may be determined based on the highest capability active. For example, if modular protocol defines a minimum capability or baseline module, while additional capabilities can be added (e.g., higher throughput, lower latency, additional carriers, wider bandwidth), then the current operation mode may correspond to that module with the highest capability or category.

Multiple operation modes may be active at the same time. For example, the mobility operation mode may determine what type of measurements and mobility are used. The L2 operation mode may determine the peak data rate. Each of these operation modes may impact the procedures for cell selection and/or reselection and re-establishment independently, or a combination of modes may be used to determine the procedural choices.

To identify which configuration parts are applicable in which cells, an identifier may be used. For example, a configuration part may be provided to the WTRU with and associated one or more identifiers.

The identifier may be a single identifier, which would also be part of a candidate configuration (e.g., LTM candidate configuration) or obtained from a cell during system information reception or during RRC re-establishment. In other words, each cell has an allowed list of modules or configuration parts and this is indicated either by the cell itself, or by a cell providing configurations for neighbors.

The module IDs may be applicable within a given area. For example, a configuration part or module may be associated with a list of cell IDs for which this is applicable, and may include cells not configured (e.g., as LTM candidates). Another example would be to make the module IDs applicable within a given PLMN, location area, RAN notification area, or any other area definition which may be defined for other cellular networks.

The module IDs may be implicit. For example, the module ID may depend on the index within a list structure (e.g., in ASN.1) configured to the WTRU (e.g., list entry 0, is ID 0, and so on).

Module IDs may be grouped according to the functionality. For example, module IDs may be grouped according to (i) DU related configuration (e.g., MAC, L1) which may be common amongst cells belonging to one DU; (ii) CU related configuration (e.g., PDCP, RRC) which may be common amongst cells belonging to one DU; (iii) RU related configuration (e.g., L1) which may be common amongst cells belonging to one RU; (iv) power saving configuration (e.g., DRX configuration, RS and measurement type); (v) mobility configuration (e.g., perform L1 based mobility, L3 based mobility, CHO, cell reselection, etc.); (vi) service related configuration (e.g., baseline capability, eMBB capability, URLLC, etc.); (vii) protocol layer specific configuration (e.g., MAC, RLC, etc.); (viii) configurations related to specific features (e.g., carrier aggregation, network energy saving (NWES), etc.) and/or (ix) according to any of the options described for “modular protocol”.

If there are multiple module groups, each of the module groups may be indexed independently. For example, DU specific modules may have an index, and CU specific modules may have an index. When the WTRU moves to a new cell, then both the DU module index and CU module index may be checked. The DU index may be the same amongst cells with the same DU, for example, meaning the same module configuration may be used in both cells.

A combination of indexes may need to be matched in order to re-use the same configuration. For example, DU modules indexes may only be valid within a single CU. In this case, a WTRU may consider DU index X to be valid as long as the CU module does not change. Otherwise the WTRU needs to consider no DU index to match when the CU index changes. This may be the case, for example, if the CU is responsible for assigning DU indexes, while the DU indexes are not shared across CUs. In this case, when the WTRU determines that the CU index changes, it may consider all of the stored DU modules to be invalid. In another example, DU indexes may be provided per CU. A particular DU may be indexed by using 2 IDs: CUID, DUID. CUID1 may be associated with DUID1 and DUID2. CUID2 may be associated with a DUID1 and DUID2. In order to determine the validity of a stored module, the same CUID and DUID may need to be matched. In such example, there are 4 DU modules which may be referenced as (CUID1, DUID1), (CUID1, DUID2), (CUID2, DUID1), (CUID2, DUID2).

Every module of a particular group may have a unique ID, at least within a particular area. In the above example, the DUIDs would be set to 1, 2, 3, 4. Cells 1 and 2 belonging to CU1 would simply not set DUID 3 and 4. This may be simpler for WTRU implementation, but may require more coordination in the network.

Based on the stored configuration part IDs, the WTRU may determine which are applicable in a new cell. To do this, the WTRU may need to receive, with the configuration part, an area in which the configuration part is applicable. This may comprise one or more of a list of cell IDs, a list of DU or CU IDs, a list of public land mobile networks (PLMNs), a list of location areas or RAN notification areas. The configuration part IDs may be provided with the configuration part and the WTRU may receive a configuration indicating for each cell which of the configuration parts are applicable. This configuration may be provided from the broadcast system information in each of the cells and/or as a neighbor configuration for the current cell.

The WTRU may be configured with MAC configuration parts with IDs 0, 1, 2, 3. A new cell may indicate that it supports MAC ID 0, 1. The WTRU may apply MAC configuration 0 or 1.

The determination of the module to apply may further depend on the current operation mode if more than one of the stored modules are applicable. For example, the WTRU may first determine, based on the identities of the currently active configuration parts and the configuration part identifiers corresponding to the second cell, which of the currently active configuration parts can remain active. In other words, the WTRU may first attempt to keep the currently active configuration parts without changing anything.

For any configuration parts corresponding to the active configuration or operation mode which are not valid in the new cell, the WTRU may determine, based on the identities of the stored (but not currently active) configuration parts and the configuration part identifiers corresponding to the second cell, which of the stored configuration parts may be applied. In other words, for the configuration parts that cannot be kept active, the WTRU may check if any of the stored configuration parts can be used instead.

If there is a valid configuration part corresponding to a stored configuration part, but not the active configuration, the WTRU may further determine whether the stored configuration part is suitable for use in the new cell or not. For example, if a stored configuration part offers less power saving, but provides sufficient peak throughput for the current service, then the configuration part may be used. Otherwise, the WTRU may determine that the stored configuration part, although supported in the new cell, is not suitable for the current operation mode (e.g., service).

The WTRU may determine the most suitable stored configuration from the applicable ones. For example, if the WTRU is in a power saving mode with a longer DRX cycle than any supported in the new cell, the WTRU may select the stored configuration which uses the longest DRX cycle of the stored configurations. A WTRU configured with a high peak data rate may select the configuration part offering the highest peak throughput from the applicable ones.

The configuration parts may be considered as matched only if all parts are matched. For example, a particular operation mode may depend on all of the parts being matched. If this is the case, the WTRU may send an indication of matched or not, and the network needs to respond with explicit configuration.

Once the WTRU has determined the applicable modules, the WTRU may apply, or maintain, the associated configurations. The “missing” configuration parts may then be obtained from the new cell.

The WTRU may indicate the matched configuration part IDs. There may be one ID signaled per “group” (e.g., a MAC ID, a mobility ID, and so on). The network may infer from this, not only the configuration parts which the WTRU has applied, and therefore what configuration the network needs to apply, but also the parts which need to be explicitly configured.

The WTRU may indicate which groups or IDs did not match, which may be interpreted as a request for configuration of these parts. The WTRU may additionally indicate an operation mode or access type to inform the network what type of configuration is needed (e.g., a power saving configuration or a high throughput configuration).

An index may be used to indicate a combination of modules. For example, a combination of MAC, L1, RRC modules may be indicated with a single identifier. The network may then choose to accept or update any of the individual modules referred to.

When the network receives the indication of matched configuration part IDs, or operation mode or access type, and infers the missing configuration parts, the network may provide a configuration via dedicated signaling (e.g., an RRC reconfiguration or a MAC CE).

The configuration may include confirmation that the applied stored configurations has been successful. The configuration may override the application of stored configurations (e.g., by providing an explicit configuration for that module or some of the parameters in that module). The network may decide to override all of the stored configurations and provide a complete configuration.

The network may provide only the missing configuration parts. The WTRU may then imply, based on not receiving any configuration which overrides one or more configuration parts, that the applied stored configuration has been confirmed by the network.

The WTRU may apply a default configuration for the missing modules. For example, a default module configuration for each operation mode may be defined in the standard or may be configured via system information. In such cases, the WTRU may indicate which of the configuration parts applied were previously stored and which are “default” configurations. However, the network may not necessarily need to further provide an explicit configuration for those.

The network may reconfigure one or of the selected and applied module by way of providing an index or ID to another of the stored configurations. For example, the WTRU might determine MAC configuration 1 should be used, while the network (assuming coordination between the source and target cell) may indicate another MAC configuration ID.

A WTRU may determine a preferred “access type” to use when receiving or requesting system information or other configuration signaling to camp/connect to a cell. As used herein, an access type may refer to a configuration which comprises one or more configuration parts. Configuration parts, in turn, may refer to different features, modes, and/or capabilities. For example, “power saving access” may correspond to a power saving configuration. A WTRU may support one or more access types. Similarly, the network may indicate support for one or more access types.

An access type may be selected based on, or correspond to, one or more of the following properties: (i) currently stored or currently active modules, configuration parts, or operation modes, (ii) WTRU capability, (iii) type of access, (iv) user or service preference, (v) service type, (vi) configuration/assignment of access type, and/or (vii) selection of access type.

An access type may be selected on, or correspond to, currently stored or currently active modules, configuration parts, or operation modes. For example, the WTRU may determine an access type based on the configuration currently used before performing a cell selection/reselection (e.g., having a power saving configuration then performing cell reselection, or a low latency configuration or high throughput configuration then performing re-establishment following RLF, etc.).

An access type may be selected on, or correspond to, WTRU capability. For example, WTRU capability may comprise one or more of: (i) maximum capability of a device (e.g., RedCap/narrowband), eMBB, URLLC, etc., (ii) supported bands or bandwidths, (iii) number of supported carriers for carrier aggregation, (iv) maximum supported data rate, (v) support for certain features (e.g., dual connectivity, extended reality (XR), artificial intelligence/machine-learning (AI/ML), and/or (vi) support for a particular set of features.

An access type may be selected on, or correspond to, type of access. For example, the WTRU may simply be camping on a cell in which case a minimum performing access type may be used. The WTRU may need to also connect to the cell, in which case a higher performing access type may be requested.

An access type may be selected on, or correspond to, user or service preference. For example, the device may be configured in a power saving mode. The WTRU may select a more power efficient access type. Otherwise, the WTRU may select a higher performing access type.

An access type may be selected on, or correspond to, service type. For example, whether the WTRU is connecting to the cell for a particular type of service with certain QoS requirements, or certain data type, including but not limited to: a small data transmission, video stream, voice, web-based connectivity, high priority access or emergency, broadcast service, machine type communication, registration or attach, sensing data, AI/ML data collection, and/or low priority data report.

An access type may be selected on, or correspond to, configuration and/or assignment of access type. For example, the network may assign a particular access type to a WTRU when it first registers on the network. This may be based on a non-access stratum (NAS) level exchange on WTRU capabilities or services, or based on a subscription type. The access type may be first access or subsequent access. For example, a minimum capability may be used to perform the registration signaling for all devices. Any subsequent access may depend on WTRU capability or any other property that may be used to determine an access type.

An access type may be selected on, or correspond to, selection of access type. The WTRU may select an access type based on any of the above criteria, in combination with an indication of what the network supports. For example, an indication of one or more supported access types may be received. The WTRU may then select one of the supported access types indicated by the network. This may not be the preferred access type. For example, the WTRU may prefer a high capability access type, but the network may only enable minimum capability access type. In this case the WTRU may need to select minimum capability access type and/or may request further information later. For example, the WTRU may receive the second system information and connect using a default configuration. The WTRU may later receive dedicated signaling to provide additional capabilities or resource configurations.

The WTRU may additionally, or alternatively, select an access type based on whether and what information it already has about the cell. For example, the WTRU may have previously accessed the cell and stored some minimum capability information about the cell. The WTRU may determine that this stored information is still valid (e.g., by use of value tags similar to NR) and request only the information which is still missing but needed (e.g., the information related to higher capabilities). One of more specific access types may be defined to make this type of request, such that the WTRU can request minimum capability and/or maximum capability parameters.

The WTRU may transmit an indication in the uplink with an indication of the selected access type. The WTRU may transmit an indication in the uplink with an indication of the selected access type if the configuration corresponding to the selected access type is not currently being transmitted or is not currently enabled.

The uplink indication may correspond to any signal in the uplink which is transmitted by the WTRU to indicate or request the module to be configured and/or to indicate that the WTRU has applied a certain combination of configurations and their identities. Based on the indication and the selected access type, the cell may present itself accordingly. For example, a cell may configure itself (e.g., from the WTRU point of view) based on a low capability device, if the low capability access type is selected. The cell may configure itself based on a high capability device if a high capability access type is indicated.

The uplink signal may be one or more of (i) random access preamble; (ii) an uplink reference signal (e.g., SRS); (iii) a dedicated physical resource, such as a shared configured grant or a scheduled grant (e.g., PUSCH); (iv) an indication may be sent, for example, as a re-establishment request (e.g., in RRC), in a Msg3 or Msg5 of a RACH procedure, and/or in a first uplink transmission following a RACH-less access; and/or (v) a “low power” wake up signal, using a power efficient modulation scheme such as on-off keying (OOK) and/or transmitted using a power efficient radio transmitter. In NR, the WTRU may transmit a wake-up signal in the uplink using a preamble configuration received from a neighbor cell. In some embodiments, a preamble configuration may be received. In some embodiments, another type of uplink signal may be configured, for example, one or more uplink reference signals (e.g., SRS and/or the like). A low power wake-up signal may be configured by indicating a reference index to one or more predetermined configs (e.g., a table in the standard).

The uplink signal may be sent using the resources, channel, and/or carrier corresponding with an initial configuration. For example, if a cell is configured with one initial, access, and/or anchor carrier, and other carriers for particular services, then the wake-up signal may be sent to the initial, access, and/or anchor carrier. In another example, a wake-up signal may be sent to the carrier or resources corresponding to the selected access type.

The uplink signal may contain an indication of the requested access type, such as (i) an explicit indication using a numerical value to indicate a selected access type; (ii) an explicit index using a reference to one of a list of supported access types provided by the network and/or an index to one or more protocol modules, configuration parts, and/or operation modes; and/or (iii) an implicit indication. An implicit indication may be a use of a particular reference sequence. An implicit indication may be a user of a particular resource. For example, a particular one or group of preambles, a particular time or frequency resource, sending the wake up to a particular carrier (e.g., if access types are associated with carriers).

In response to receiving an indication of the requested access type, the network may enable this access type. For example, a WTRU performing cell reselection and indicating that it requests a power saving configuration may be provided with a power saving configuration in response to the request.

The access type may correspond to modules, configuration parts, and/or operation modes which are currently active, currently preconfigured, and/or stored in the WTRU. The WTRU may indicate multiple access types (e.g., multiple module IDs, multiple configuration parts, and/or multiple operation modes) depending on what is currently active and/or configured in the WTRU. In the context of cell reselection or RRC re-establishment, this may be a request to enable certain configurations which are known to the WTRU as being available in the new cell, but which may not be currently active in the new cell. The request may be transmitted by the WTRU before the cell selection/reselection either to the current cell or the target cell. Additionally, or alternatively, the request may be transmitted as part of the establishment/re-establishment procedure which occurs during/after the cell selection/reselection.

A WTRU may receive configuration parts. Each configuration part may correspond to protocol modules. The configuration parts may be for first (e.g., current) cell. The configuration parts may also be for candidate cells. Each configuration part may be associated with an identifier.

When the WTRU detects a failure (e.g., RLF), a second (e.g., new) cell may be selected. The WTRU may compare identifiers corresponding to the second cell to those identifiers corresponding to stored configuration parts. The WTRU may apply the stored configuration parts with matched identifiers.

The WTRU may indicate to the second cell (e.g., in a RRC Connection re-establishment request) matched/unmatched identifiers. The WTRU may then receive (e.g., via RRC connection re-establishment) missing and/or unmatched configuration parts and may apply those.

A WTRU may receive, from a first cell, one or more configuration parts, and one or more configuration part identifiers for determining applicability. Configuration parts may correspond to “protocol modules” applicable in certain operation modes. Configuration parts may be applicable within multiple cells, and for particular operation modes

The WTRU may activate one or more configuration parts. The WTRU may active one or more configuration parts based on an explicit indication from network and/or based on one or more conditions. The one or more conditions may be based on one or more measurements associated with one or more cells (e.g., a serving cell measurement is above a threshold, a neighbor cell measurement is better than the serving cell, etc.) and/or timer-based (e.g., if there is a DRX timer whereby no data has been scheduled for a certain time, the power saving configuration may be activated).

The WTRU may detect an RRC Connection failure on the current cell (e.g., RLF, HOF, reconfiguration failure, security failure, RLC failure, etc.). The WTRU may perform measurements and select a second cell (e.g. perform cell selection).

The WTRU may receive the relevant configuration part identifiers corresponding to the second cell. For example, the WTRU may acquire the system information (e.g., just the minimum system information).

The WTRU may determine the configuration parts applicable in the second cell based on the one or more stored configuration parts which have the same value as the configuration part identifiers received on the second cell. Each configuration part may have an ID that is also present in the second cell and/or is valid in the second cell.

The WTRU may apply the stored configuration parts having identifiers corresponding to the second cell which match the identifiers of the stored configuration parts. This may include keeping the matched active configuration parts.

The WTRU may indicate (e.g., in RRC Re-establishment request) the source cell identifier and the stored identifiers. The store identifiers may be for both the matched and unmatched configuration parts.

The WTRU may receive a configuration for the unmatched configuration parts. The WTRU may apply the unmatched configuration parts on top of the already applied configuration parts.

RRC Re-establishment signaling and latency may be minimized by allowing the WTRU to apply the relevant configuration parts already stored that are applicable to the new cell, even if it is not a configured mobility candidate, and as long as it belongs to a certain group of cells (e.g. same DU, same CU, same RNA, etc.)

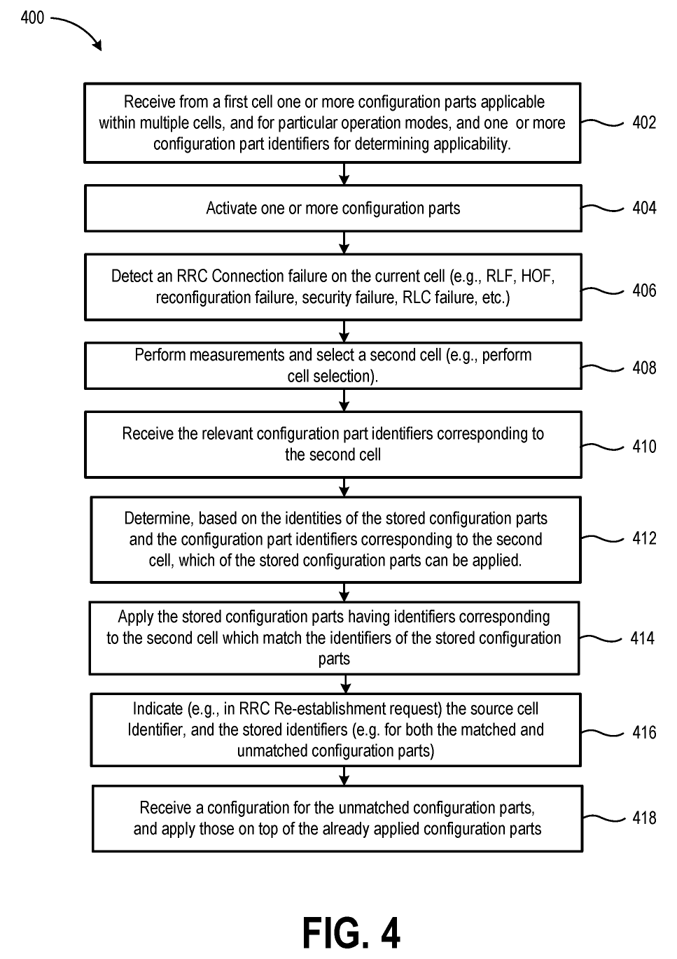

FIG. 4 is a flowchart 400 illustrating a re-establishment procedure according to an embodiment. The method may be implemented by a WTRU. At 402, the WTRU may receive, from a first cell, one or more configuration parts applicable within multiple cells, and for particular operation modes, and one or more configuration part identifiers for determining applicability. At 404, the WTRU may activate one or more configuration parts. At 406, the WTRU may detect an RRC Connection failure on the current cell (e.g., RLF, HOF, reconfiguration failure, security failure, RLC failure, etc.). At 408, the WTRU may perform measurements and select a second cell (e.g., performs cell selection). At 410, the WTRU may receive the relevant configuration part identifiers corresponding to the second cell. At 412, the WTRU may determine, based on the identities of the stored configuration parts and the configuration part identifiers corresponding to the second cell, which of the stored configuration parts can be applied. At 414, the WTRU may apply the stored configuration parts having identifiers corresponding to the second cell which match the identifiers of the stored configuration parts. At 416, the WTRU may indicate (e.g., in RRC re-establishment request) the source cell identifier, and the stored identifiers (e.g., for both the match and unmatched configuration parts). At 418, the WTRU may receive a configuration for the unmatched configuration parts, and may apply those on top of the configuration parts already applied.

The WTRU may be first pre-configured with multiple configuration parts. Each of the configuration parts may be applied together with other configuration parts to form a complete configuration. For example, there may be multiple MAC configuration parts which define different MAC configurations. Depending on which operation mode the network wants to use, the network may enable one or more of the MAC configurations. One MAC configuration may be for a relatively low throughput, which might use fewer HARQ processes and a less aggressive transmission mechanism, and another MAC configuration may use more HARQ processes and a more aggressive transmission mechanism. Additionally, or alternatively, the network may enable one or more DRX configurations, where one may provide better power saving (e.g., a longer DRX cycle) and another may provide better latency (e.g., a shorter DRX cycle).

Following the pre-configuration, the network may signal a configuration to use (e.g., one or more configuration parts to combine). This may be signaled in RRC or it may be a MAC CE or other downlink signaling. The configuration may be a list of configuration part IDs, or may be an ID which references a group of configuration parts. For example, a full configuration ID might be associated with multiple configuration part IDs.

Upon determining a failure on the source cell (e.g., RLF), the WTRU may select another cell and attempt to camp. As part of the cell selection process, the WTRU may receive system information from the selected cell, including a list of supported or active configuration part IDs.

In some embodiments, all of the currently active configuration parts may be supported in the new cell. In this case, the WTRU may keep all of the currently active configuration parts as the current configuration, potentially modifying some cell specific parameters such as physical cell ID.

In some embodiments, the WTRU may determine that some or all of the currently active configuration parts are not supported in the new cell. In such embodiments, the WTRU may deactivate the unsupported configuration parts. The WTRU may determine for some of these configuration parts that another stored configuration part is suitable. For example, the new cell may not support the currently active MAC configuration, but may support another of the stored MAC configurations.

The WTRU may determine that it does not have a stored configuration part for a particular active operation mode or module. For example, the WTRU may determine that none of the stored MAC configurations are supported in the new cell. In this case, the WTRU may indicate to the network which of the stored configuration parts are enabled (e.g., kept active and/or activated upon cell switch) and which of the configuration parts are missing. When the new cell receives this indication, the new cell can provide an explicit configuration, or an implicit indication of a configuration, corresponding to the missing or unmatched configuration parts. The WTRU may need to completely deactivate an unsupported module in the new cell. For example, a low latency high throughput module may not be supported in the new cell and therefore the WTRU may need to deactivate the configuration or service either implicitly or upon indication from the network.

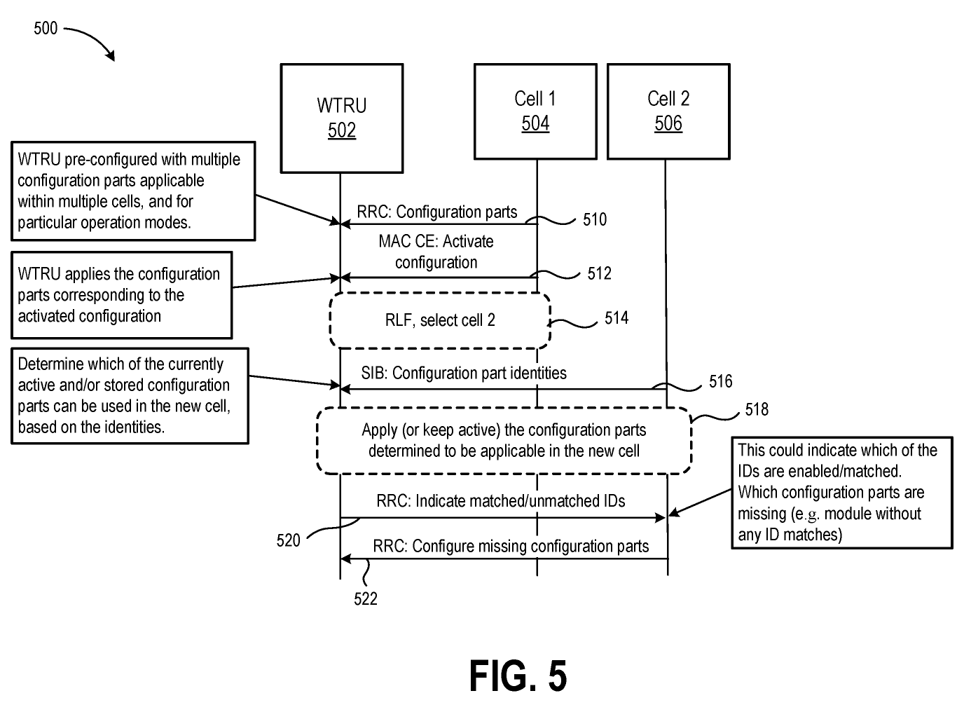

FIG. 5 is a flow diagram 500 illustrating a re-establishment procedure according to an embodiment. At 510, a WTRU 502 may receive configuration parts from a first cell 504. The configuration parts may be applicable within multiple cells and for particular operation modes. In this way, WTRU 502 may be pre-configured with multiple configuration parts.

At 512, WTRU 502 may receive an indication to activate configuration (e.g., via MAC CE). In this way, WTRU 502 may apply the configuration parts corresponding to the active configuration. At 514, a second cell (cell 2) 506 may be selected. At 516, WTRU 502 may receive, from second cell 506, configuration part identities (e.g., via SIB). WTRU 502 may determine which of the currently active and/or stored configuration parts can be used in second cell 506 (the new cell), based on the identities. At 518, configuration parts determined to be applicable in second cell 506 may be applied and/or kept active. At 520, WTRU 502 may indicate, to second cell 506, matched/unmatched IDs (e.g., via RRC message). This may indicate which of the identifiers are enabled and/or matched. Additionally, or alternatively, this may indicate which configuration parts are missing (e.g., a module without any identifier matches). At 522, WTRU 502 may receive, from second cell 506, a configuration for unmatched and/or missing configuration parts (e.g., via RRC).

1. A wireless transmit/receive unit (WTRU) comprising:
a processor configured to:
determine that a first set of configuration parts are activated for the WTRU for a serving cell, wherein a first respective identifier is associated with each configuration part of the first set of configuration parts, and wherein each configuration part of the first set of configuration parts corresponds to a protocol module that is applicable in one or more operation modes;
detect a connection failure with the serving cell;
select a target cell;
receive an indication of second respective identifiers associated with each configuration part of a second set of configuration parts, wherein the second set of configuration parts are associated with the target cell;
determine, based on the first respective identifiers and the second respective identifiers, a matched portion of the second set of configuration parts that are included in the first set of configuration parts that are activated for the WTRU for the serving cell, and an unmatched portion of the second set of configuration parts that are not included in the first set of configuration parts that are activated for the WTRU for the serving cell;
send, to the target cell, an indication of respective identifiers of the matched portion of the second set of configuration parts; and
receive, from the target cell, a configuration for a subset of the unmatched portion of the second set of configuration parts that are associated with the target cell.

2. The WTRU of claim 1, wherein each configuration part of the first set of configuration parts comprises at least a partial configuration for one or more target cells.

3. The WTRU of claim 1, wherein each operation mode of the one or more operation modes is associated with one or more capabilities of the WTRU.

4. The WTRU of claim 1, wherein the processor is further configured to:
apply the matched portion of the second set of configuration parts and the unmatched portion of the second set of configuration parts, wherein, together, the matched portion of the second set of configuration parts and the unmatched portion of the second set of configuration parts form a full configuration for the WTRU with the target cell.

5. The WTRU of claim 1, wherein the processor is further configured to:
receive configuration information, wherein the configuration information comprises more configuration parts than the first set of configuration parts that are activated for the WTRU.

6. The WTRU of claim 1, wherein the processor is further configured to:
determine that at least one configuration part of the first set of configuration parts that are activated are applicable in the target cell based on an identifier associated with the at least one configuration part having the same value as an identifier associated with at least one configuration part of the second set of configuration parts associated with the target cell.

7. The WTRU of claim 1, wherein the processor is further configured to:
send, to the target cell, an identifier associated with the serving cell.

8. The WTRU of claim 1, wherein the first set of configuration parts and the second set of configuration parts are applicable within multiple cells and for particular operation modes.

9. The WTRU of claim 1, wherein the processor is further configured to:
activate the first set of configuration parts based on an indication from the serving cell or based on detection of one or more conditions, wherein the one or more conditions comprise at least one of (i) one or more measurements associated with at least one of a source cell or a neighboring cell, or (ii) one or more timers.

10. The WTRU of claim 1, wherein the processor is further configured to:
detect the connection failure with the serving cell based on a radio link failure, a hand-over failure, a reconfiguration failure, a security failure, or a radio link control failure.

11. A method implemented by a wireless transmit/receive unit (WTRU), the method comprising:
determining that a first set of configuration parts are activated for the WTRU for a serving cell, wherein a first respective identifier is associated with each configuration part of the first set of configuration parts, and wherein each configuration part of the first set of configuration parts corresponds to a protocol module that is applicable in one or more operation modes;
detecting a connection failure with the serving cell;
selecting a target cell;
receiving an indication of second respective identifiers associated with each configuration part of a second set of configuration parts, wherein the second set of configuration parts are associated with the target cell;
determining, based on the first respective identifiers and the second respective identifiers, a matched portion of the second set of configuration parts that are included in the first set of configuration parts that are activated for the WTRU for the serving cell, and an unmatched portion of the second set of configuration parts that are not included in the first set of configuration parts that are activated for the WTRU for the serving cell;
sending, to the target cell, an indication of respective identifiers of the matched portion of the second set of configuration parts; and
receiving, from the target cell, a configuration for a subset of the unmatched portion of the second set of configuration parts that are associated with the target cell.

12. The method of claim 11, wherein each configuration part of the first set of configuration parts comprises at least a partial configuration for one or more target cells.

13. The method of claim 11, wherein each operation mode of the one or more operation modes is associated with one or more capabilities of the WTRU.

14. The method of claim 11, further comprising:
applying the matched portion of the second set of configuration parts and the unmatched portion of the second set of configuration parts associated with the target cell, wherein, together, the matched portion of the second set of configuration parts and the unmatched portion of the second set of configuration parts form a full configuration for the WTRU with the target cell.

15. The method of claim 11, further comprising:
receiving configuration information, wherein the configuration information comprises more configuration parts than the first set of configuration parts that are activated for the WTRU.

16. The method of claim 11, further comprising:
determining that at least one configuration part of the first set of configuration parts that are activated are applicable in the target cell based on an identifier associated with the at least one configuration part having the same value as an identifier associated with at least one configuration part of the second set of configuration parts associated with the target cell.

17. The method of claim 11, further comprising:
sending, to the target cell, an identifier associated with the serving cell.

18. The method of claim 11, wherein the first set of configuration parts and the second set of configuration parts are applicable within multiple cells and for particular operation modes.

19. The method of claim 11, further comprising:
activating the first set of configuration parts based on an indication from the serving cell or based on detection of one or more conditions, wherein the one or more conditions comprise at least one of (i) one or more measurements associated with at least one of a source cell or a neighboring cell, or (ii) one or more timers.

20. The method of claim 11, further comprising:
detecting the connection failure with the serving cell based on a radio link failure, a hand-over failure, a reconfiguration failure, a security failure, or a radio link control failure.
